(19) United States
(12) Patent Application Publication
(10) Pub. No.: US 2009/0081615 A1
(43) Pub. Date: Mar. 26, 2009

(54) METHOD OF REGISTERING A DENTAL MODEL ON A TRAY BASE

(76) Inventor: Yunoh Jung, Murray, UT (US)

Correspondence Address: THORPE NORTH & WESTERN, LLP., P.O. Box 1219, SANDY, UT, 84091-1219, US

(21) Appl. No.: 12/236,235

(22) Filed: Sep. 23, 2008

Related U.S. Application Data
(60) Provisional application No. 60/995,250, filed on Sep. 24, 2007.

(51) Int. Cl. A61C 13/00

(52) U.S. Cl. 433/213; 433/215

(57) ABSTRACT

A method for registering a dental model on a tray base includes obtaining a dental model that is an impression of at least some of a patient's teeth; disposing the dental model on a tray base; drilling at least one registration pin hole from a bottom of the tray base, through the tray base, and into a bottom of the dental model while the dental model is disposed on the tray base; and inserting at least one registration pin into the at least one registration pin hole with the at least one registration pin extendable between the dental model and the tray base.

### CLAIM OF PRIORITY

Priority of U.S. Provisional Patent Application Ser. No. 60/995,250 filed on Sep. 24, 2007 is claimed, and which is herein incorporated by reference for all purposes.

### BACKGROUND

1. Field of the Invention

The present invention relates generally to dental modeling and methods. More particularly, the present invention relates to a method of registering a dental model on a tray base.

2. Related Art

The production of a dental prostheses, such as a crowns, bridges, caps, inlays, onlays or other restorative dental work, involve the production of a dental model which is a duplication of the patient's teeth upon which the prosthesis can be fabricated. Conventional dental models are made from a negative impression of the patient's teeth obtained by a dentist. Dental labs then fill the negative impression with dental casting material, such as dental gypsum, that hardens forming the dental model.

The dental model is typically supported by and removably secured to a base. The base is often formed of plastic or stone, or is a plastic base or a stone base. The dental model can be segmented or cut around one or more sectioned dies (or tooth model) to allow the sectioned die to be removed from the rest of the dental model and base. The dental model and sectioned die can be registered on the base using pins that extend between the model or sectioned die and the base. The pins allow for better control and ease of handling of the small sectioned dies.

Assembling the dental model, base and pins can be done in different manners, such as wet pinning or dry pinning. In wet pinning, pins are placed into holes in the plastic base so that the pins extend from the plastic base. Dental gypsum is poured between the base and the negative impression, and around the pins, thus wetting the pins. The pin holes in the plastic base can be premolded into the plastic base. For example, see U.S. Pat. Nos. 4,608,016; 4,708,835; and 6,217,326. Alternatively, the pin holes can be custom located by drilling into the upper surface of the plastic base prior to pouring the dental gypsum. For example, see U.S. Pat. No. 4,371,339 or 5,098,290.

In dry pinning, the dental model is separately formed by pouring dental gypsum into the negative impression and allowing the dental gypsum to harden into the dental model. Holes are formed into the dried and hardened dental model and pins inserted and glued with the pins extending from the dental model. A second-pour stone base is then poured around the pins. For example, see U.S. Pat. No. 4,481,162.

In either of the wet pinning or dry pinning techniques described above, dental gypsum is poured around a pin that is already set in either the plastic base, or the dried and hardened dental model. One problem with the dental gypsum on either the dental model or stone base is that the dental gypsum expands as it cures or dries. The expansion of the dental gypsum around the set pin causes horizontal tension to be placed on the pin. This causes difficult removal and replacement of the dental model or sectioned die with respect to the base. When the dental model or sectioned die is removed from the base, the tension is released and the pin can move slightly. As a result, reseating the pin can be difficult.

In addition, ready-made dry dental models have been proposed. These models are formed through a digital process in which the patient's teeth are digitally scanned, and then the dental model is made by milling, fused deposition modeling, stereo-lithography, or other rapid prototyping methods using the digital scan of the patient's teeth. Securing such ready-made dry dental models to a base would presumably use the dry pinning technique of forming a hole in the bottom of the model, and inserting and gluing pins into the holes, and then pouring a stone base around the pins. Again, as described above, dental gypsum is poured and cured around a fixed pin, inducing stress on the pin and causing removal and replacement difficulties.

### SUMMARY OF THE INVENTION

It has been recognized that it would be advantageous to develop a method of registering a dental model and/or sectioned dies of a dental model to a base using registration pins but without introducing stress or strain on the pins from expansion of curing dental casting material such as gypsum. In addition, it has been recognized that it would be advantageous to develop a method of registering a ready-made dry dental model to a plastic base.

The present invention can provide for a method for registering a dental model on a tray base including obtaining a dental model of at least some of a patient's teeth. The dental model is disposed on a tray base. At least one registration pin hole is drilled from a bottom of the tray base, through the tray base, and into a bottom of the dental model. At least one registration pin is inserted into the at least one registration pin hole with the at least one registration pin extendable between the dental model and the tray base.

The present invention also provides a method for registering a dental model on a tray base including obtaining a dental model of at least some of a patient's teeth. The dental model can include a dental modeling material that is substantially cured. The dental model is disposed on a tray base. The tray base can be formed of a castable or pourable molding material that is substantially cured. At least one registration pin hole is drilled from a bottom of the tray base, through the tray base, and into a bottom of the dental model while the dental model is disposed on the tray base and after both a material of the tray base and the dental modeling material of the dental model are substantially set or cured. At least one registration pin is inserted into the at least one registration pin hole with the at least one registration pin extendable between the dental model and the tray base. The at least one registration pin is fixed to the dental model or the tray base.

The present invention also provides a method for registering a dental model on a tray base including obtaining a dental model of at least some of a patient's teeth. The dental model can include a dental modeling material that is substantially cured. The dental model is disposed on a plastic tray base. At least one registration pin hole is drilled from a bottom of the tray base, through the plastic tray base, and into a bottom of the dental model while the dental model is disposed on the plastic tray base and after both a material of the plastic tray base and the dental modeling material of the dental model are substantially set or cured. At least one registration pin is inserted into the at least one registration pin hole with the at least one registration pin extendable between the dental model and the plastic tray base. The at least one registration pin is fixed to the dental model or the plastic tray base.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a schematic side view of a dental prosthesis modeling system in accordance with an embodiment of the present invention;

FIGS. 2a, 3a, 4a and 5a are perspective views of tray bases for use with the dental prosthesis modeling system of FIG. 1 and a method of the present invention in accordance with embodiments of the present invention;

FIGS. 2b, 3b, 4b and 5b are end views of the tray bases of respective FIGS. 2a, 3a, 4a and 5a;

FIGS. 6-10 are schematic side views of a method of registering a dental model to a tray base in accordance with an embodiment of the present invention;

FIGS. 11 and 12 are schematic side views of an alternative method of registering a dental model to a tray base in accordance with another embodiment of the present invention;

FIG. 13 is a graph of general expansion of dental casting material versus time; and

FIG. 14 is a graph of expansions of dental casting materials versus time.

### DETAILED DESCRIPTION OF EXAMPLE EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### DEFINITIONS

The term “dental modeling material” is used broadly herein to include dental casting material, such as dental gypsum, dental plaster, dental stone, etc. and rapid prototyping materials, such as plastic, photo-sensitive polymer resin, etc.

The term “rapid prototyping” is used broadly herein to include CNC (computer numerical controlled) methods of subtracting and/or adding, stereo-lithography, selective laser sintering, three-dimensional printing, fused deposition modeling, thermal phase change inkjets, photopolymer phase change inkjets, laminated object manufacturing, laser powder forming, and the like.

The term “dental model” is used broadly herein to include a model of a user's teeth and is formed of dental modeling material. The dental model may be formed by applying dental casting material to a negative impression of the patient's teeth. The dental model may also be formed of rapid prototyping material by rapid prototyping using a digital scan of the patient's teeth. The digital scan can be a scanned intra oral image of the patient's teeth.

### DESCRIPTION

The embodiments of the present invention described herein relates generally to precise registering of a dental model onto a tray base using custom location pinholes (non-pre-perforated pinholes) in the tray base and the dental model made by utilizing a drilling method. The tray base can be a formed of a non-expanding material such as a preformed plastic base, a cast stone base, and the like. The dental model can be created either by a conventional method of pouring a casting material such as gypsum stone in a dental negative impression, or by a rapid prototyping method such as digital CNC (computer numerical control) milling, 3D printing, and the like.

In the embodiment described herein, the dental model is first situated on a die receiving surface on top of the tray base before the pin registration process. The dental model can be either created separately off the tray and temporally situated on the tray, or directly poured on the tray. The dental model can be created using conventional methods of pouring dental casting material or “stone”, or by rapid prototyping methods such as digital CNC milling, stereo-lithography, 3D printing, and the like. A registration pinhole is formed in the tray base and the dental model by a drill bit which penetrates the tray base from the opposite side of the die receiving surface (or the bottom of the tray). The drill travels through the base into a bottom surface of the cured, or ready-made dry dental model. In this way, the registration pinhole is match drilled into both the tray base and the dental model.

The head of the registration pin is then fixed tightly into the hole in the bottom of the dry model while the body of the pin goes into the tray base. Due to the match drilling process, the hole in the bottom of the dry model and the hole through the plastic base are vertically aligned, or “registered”, with one another due to the straight passage of the drill bit. A method of registering the dental model on the plastic base utilizing a dry pinning application is accomplished in this way.

One benefit of the present invention is that it provides an efficient method of registering a ready-made dental model on the tray base using a dry pinning application. Another benefit is that die reseating is easy and accurate because the model has already experienced the majority of its expansion before the registration pins are set in the dental casting material. Another benefit is that complete control of aesthetic symmetry, including a balanced look from all direction, can be achieved if the model is created and trimmed off the tray before the before the registration pins are placed in the model.

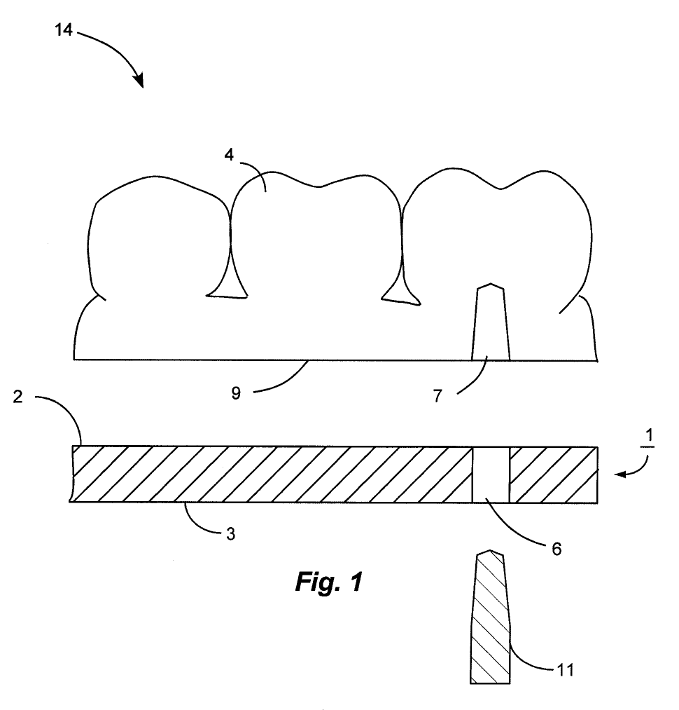

Illustrated in FIG. 1, a dental prosthesis modeling system, indicated generally at 14, is shown in accordance with an embodiment of the present invention for use in registering a dental model 4 on a tray base, indicated generally at 1. At least one registration pin, indicated generally at 11 can be disposable in a hole 6 in the tray base 1 and another hole 7 in the dental model 4. The holes 6 and 7 can be match drilled through the bottom 3 of the tray base 1 and can extend through the tray base and into the bottom 9 of the dental model 4. In this way, the holes 6 and 7 can be vertically aligned so as to precisely locate or register the dental model 4 or sections of the dental model on the tray base 1.

The method of registering, or precisely locating a dry dental model 4 to a tray base 1 by joining the model to the base with a registration pin 11 of the present invention includes obtaining a dental model 4 of at least some of a patient's teeth. As described above, in one aspect, the dental model 4 can be formed by pouring dental casting material into a negative impression (not shown) of the patient's teeth. In another aspect, the dental model 4 can be formed by rapid prototyping using scanned intra oral images of the patient's teeth. Thus, the dental model 4 can be a ready-made dry model that has been allowed to substantially cure, set, dry, etc.

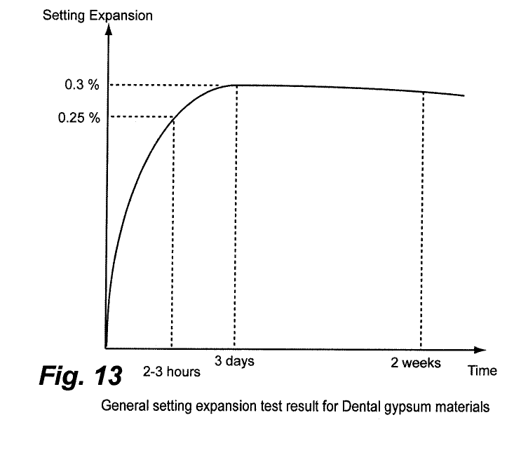

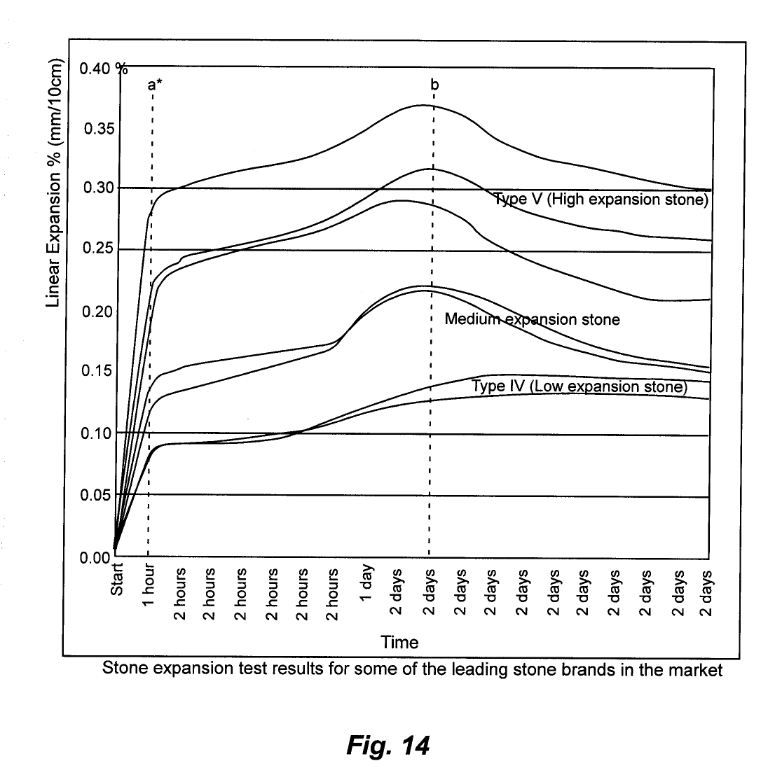

In the case of a dental model 4 formed of pourable dental casting material, it will be appreciated that the dental casting material can expand as it dries, sets, or cures. Referring to FIGS. 13 and 14, it is seen that many dental casting materials expand approximately 0.25% over approximately the first 2-3 hours, and expands approximately 0.3% within approximately 3 days. Thus, within the first 2-3 hours after pouring the dental casting material has cured approximately 83%. It is believed that allowing the dental casting material to cure at least 70% is sufficient for the present invention. In addition, it is believed that allowing the dental casting material to cure for at least one hour can be sufficient for the present invention.

In the case of a dental model 4 formed by rapid prototyping, it will be appreciated that the rapid prototyping material, such as resin, plastic, and the like can shrink as it sets, cures, dries or cools.

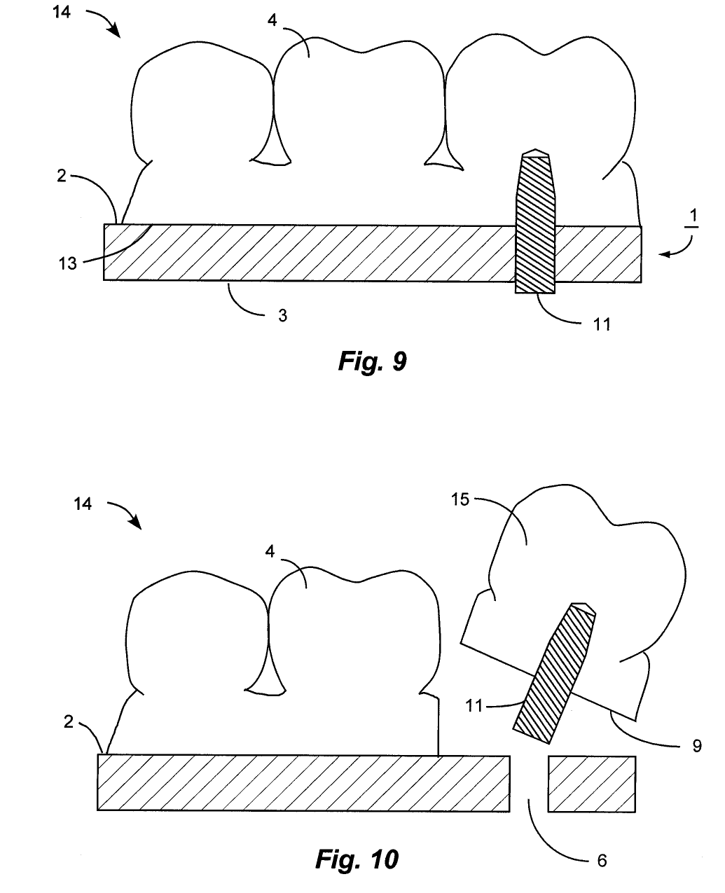

Referring to FIG. 6, the dental model 4 is disposed on a tray base 1. As mentioned above, the dental model 4 can be formed away from the tray base 1. Thus, disposing the dental model 4 on the tray base 1 can include disposing the dental model on the tray base after the dental modeling material of the dental model has substantially cured. The dental modeling material of the dental model 4 can be substantially cured prior to disposing the dental model on the tray base 1. Alternatively, the dental model 4 can be formed on the tray base 1 itself. For example, a dental modeling material such as dental gypsum can be placed into a dental impression (not shown) and the dental impression can be inverted onto the die receiving surface 2 of the base 1, thereby allowing the stone to set and harden while on the die receiving surface 2 of the tray base 1.

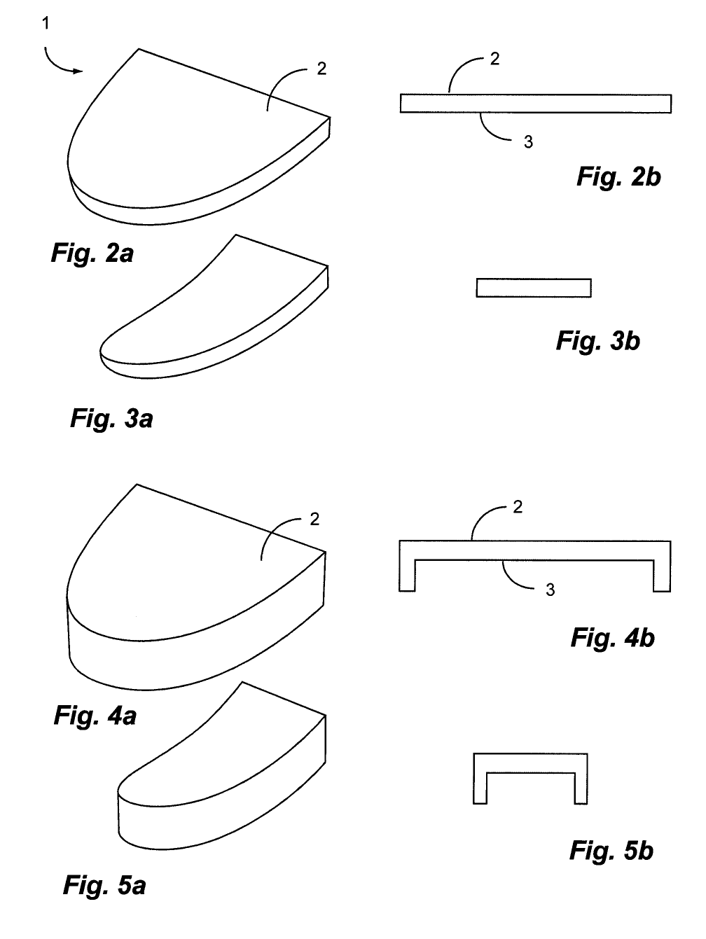

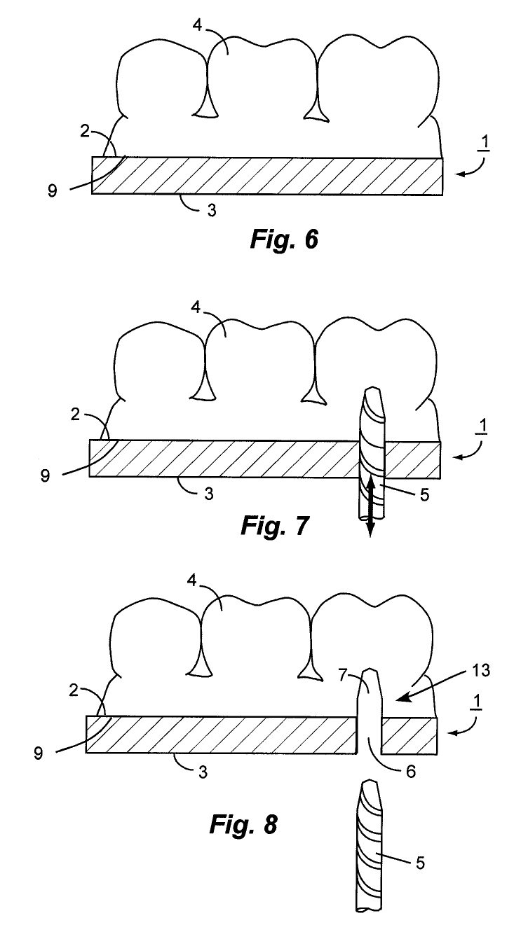

Referring to FIG. 2a, the tray base 1 can be void of pre-manufactured pinholes for the registration of the dental model. The bed or top surface can be a die receiving surface 2 of the tray base 1. The die receiving surface 2 can be either completely flat, or can have some indentation (not shown) to facilitate the initial placement of the model 4 on the base 1 in a stable manner. Individual bases can be sized and shaped to appropriately fit the model 4, corresponding to any size dental impression, as shown in FIGS. 2a-5b.

Referring to FIGS. 7 and 8, at least one registration pin hole, indicated generally at 13, or a pair of aligned pin holes 6 and 7 in the base 1 and model 4 respectively, is drilled from a bottom 3 of the tray base 1, through the tray base 1, and into a bottom 13 of the dental model 4 with a drill bit 5. The registration pin hole(s) is drilled while the dental model 4 is disposed on the tray base 1. The tray base, or its bottom 3, can be disposed on a table or support surface (not shown), below which is a drill bit 5 that travels in a vertical drill path from below, such as through a hole in the table. A guide (not shown), such as a laser light, can be disposed on an armature over the table and aligned with the drill bit. The light can shine on a top of the dental model so that the technician can position the pin hole 13 where desired. Thus, the pair of registration pin holes 6 and 7 is match drilled, or drilled in a single sequential drilling pass while the dental model 4 is disposed on the tray base 1. In addition, drilling the at least one registration pin hole 13 can include drilling the at least one registration pin hole after the dental modeling material of the dental model 4 has substantially cured.

Regardless of whether or not the model 4 was ready-made off the tray base 1 or if it was created on the die receiving surface 2 of the tray base 1, the dental model 4 can sit on the die receiving surface 2 of the base 1 while a drill bit 5 can be introduced to the bottom side 3 of the tray base 1. The bottom side 3 is the opposite side of the die relieving surface 2. The drill bit 5 can extend completely through the base 1 and into the bottom 9 (FIG. 9) of the dental model 4 that is sitting on the die receiving surface 2. Once the drill bit is removed, as in FIG. 8, there can be two vertically aligned holes 6 and 7, one of the holes 6 going through the base 1 and the other hole 7 extending into the bottom 9 of the dental model 4. In one aspect, the pin holes 6 and 7 together can form the pin hole 13.

The material of the dental model 4, and a material of the tray base 1, are substantially set or cured prior to drilling the at least one registration pin hole. Thus, drilling of the at least one registration pin hole includes drilling the at least one registration pin hole after a dental modeling material of the dental model 4 and a material of the tray base 1 are substantially set. As described above, forming the hole or holes 6 and 7 after the material of the model 4 and base 1 are substantially set or cured resists the formation of stress against the pin 11 and allows easier removal and resetting of the model 4 or segmented die on the base 1.

At least one registration pin 11 or 12 is inserted into the at least one registration pin hole 13 with the at least one registration pin extendable between the dental model 4 and the tray base 1. The vertically aligned holes 6 and 7 can receive the registration pin 11 or 12 that extends into or through the base 1 and into the dental model 4.

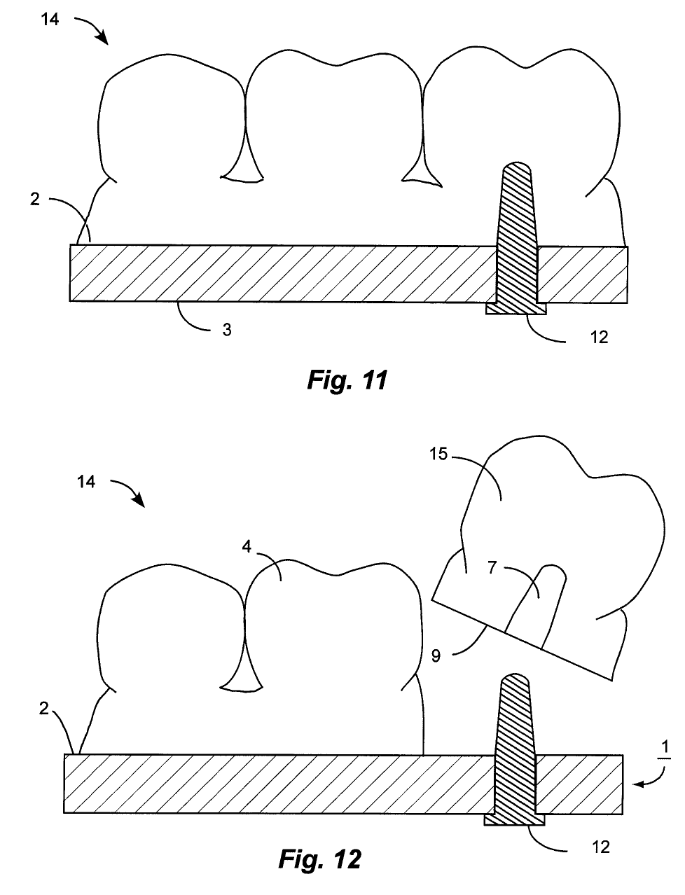

Referring to FIGS. 9 and 12, the model 4 can now be registered to the base 1 and can be removed and rejoined in the same location by fitting the registration pin 11 or 12 into the registration pin hole. In one aspect, a registration pin 11 can be fixed underneath the dental model 4 so that the pin 11 is attached to the model 4 when it is removed from the base 1, as shown in FIG. 9. In another aspect, as in FIGS. 11 and 12, the pin 12 can be fixed to the tray base 1 so that the pin 12 is attached to the base 1 when the dental model 4 is removed.

Alternatively, some pins 11 can be fixed to the dental model 4 and some pins 12 can be fixed to the plastic base 1 so that when the model 4 is removed the pins 11 fixed to the model 4 remain attached to the model 4 and the pins 12 fixed to the base 1 remain attached to the base 1. The hole 7 in the dental model 7 can be tapered, such as with a tapered drill bit, and the registration pin 11 or 12 can be press fit into the tapered hole. Thus, the drill bit can have a smaller diameter for the hole in the dental mold and a larger diameter for the hole in the tray base.

The dental model 4 can be segmented, such as on either side of the at least one registration pin hole 13, to create a segmented die 15 that can be removed from the base 4 while the rest of the dental model remains on the base 1.

Thus, the present invention can provide for a method for registering a dental model on a tray base including obtaining a dental model of at least some of a patient's teeth. The dental model is disposed on a tray base. At least one registration pin hole is drilled from a bottom of the tray base, through the tray base, and into a bottom of the dental model. At least one registration pin is inserted into the at least one registration pin hole with the at least one registration pin extendable between the dental model and the tray base.

The method can also include substantially curing a dental modeling material of the dental model prior to disposing the dental model on the tray base. In one aspect, the dental modeling material of the dental model can be cured at least 70% prior to disposing the dental model on the tray base or prior to drilling the at least one registration pin hole. In this way, the material of the dental model and a material of the tray base are substantially set prior to drilling the at least one registration pin hole.

The step of obtaining the dental model can further include obtaining a substantially cured dental model that includes a dental modeling material that has substantially cured. Additionally, the step of disposing the dental model on the tray base can include disposing the dental model on the tray base after the dental modeling material of the dental model has substantially cured, and the step of drilling the at least one registration pin hole can include drilling the at least one registration pin hole after the dental modeling material of the dental model has substantially cured.

The step of drilling the at least one hole can include drilling a pair of aligned holes with one hole in the tray base and another hole in the dental model. The pair of aligned holes can be drilled sequentially in a single drilling pass while the dental model is disposed on the tray base. Additionally, the step of drilling the at least one registration pin hole can include drilling the at least one registration pin hole after a dental modeling material of the dental model and a material of the tray base are substantially set. The step of drilling the least one registration pin hole can also include drilling the at least one registration pin hole in both the tray base and the dental model while the dental model is disposed on the tray base. In one aspect, the step of drilling the at least one registration pin hole can also include drilling at least one tapered hole.

The step of obtaining the dental model can also include forming the dental model prior to disposing the dental model on the tray base. In one aspect, the dental model can be formed by a rapid prototyping method selected from the group consisting of milling, CNC milling, 3D printing, and combinations thereof. In another aspect, the dental model can be formed by applying dental casting material to a negative impression of a patient's teeth.

In one aspect, the method can also include fixing the at least one registration pin to the dental model. In another aspect, the method can include fixing the at least one registration pin to the tray base. In yet another aspect, the method can include segmenting the dental model on either side of the at least one registration pin hole.

The present invention can also provide a method for registering a dental model on a tray base including obtaining a dental model of at least some of a patient's teeth. The dental model can include a dental modeling material that is substantially cured. The dental model is disposed on a tray base. The tray base can be formed of a castable or pourable molding material that is substantially cured. At least one registration pin hole is drilled from a bottom of the tray base, through the tray base, and into a bottom of the dental model while the dental model is disposed on the tray base and after both a material of the tray base and the dental modeling material of the dental model are substantially set or cured. At least one registration pin is inserted into the at least one registration pin hole with the at least one registration pin extendable between the dental model and the tray base. The at least one registration pin is fixed to the dental model or the tray base.

The present invention can also provide a method for registering a dental model on a tray base including obtaining a dental model of at least some of a patient's teeth. The dental model can include a dental modeling material that is substantially cured. The dental model is disposed on a plastic tray base. At least one registration pin hole is drilled from a bottom of the tray base, through the plastic tray base, and into a bottom of the dental model while the dental model is disposed on the plastic tray base and after both a material of the plastic tray base and the dental modeling material of the dental model are substantially set or cured. At least one registration pin is inserted into the at least one registration pin hole with the at least one registration pin extendable between the dental model and the plastic tray base. The at least one registration pin is fixed to the dental model or the plastic tray base.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for registering a dental model on a tray base, comprising:
a) obtaining a dental model of at least some of a patient's teeth;
b) disposing the dental model on a tray base;
c) drilling at least one registration pin hole from a bottom of the tray base, through the tray base, and into a bottom of the dental model; and
d) inserting at least one registration pin into the at least one registration pin hole with the at least one registration pin extendable between the dental model and the tray base.

2. A method in accordance with claim 1, wherein drilling the at least one hole includes drilling a pair of aligned holes, one in the tray base and another in the dental model, sequentially in a single drilling pass while the dental model is disposed on the tray base.

3. A method in accordance with claim 1, wherein obtaining the dental model includes obtaining a substantially cured dental model that includes a dental modeling material that has substantially cured; wherein disposing the dental model on the tray base includes disposing the dental model on the tray base after the dental modeling material of the dental model has substantially cured; and wherein drilling the at least one registration pin hole includes drilling the at least one registration pin hole after the dental modeling material of the dental model has substantially cured.

4. A method in accordance with claim 1, further comprising substantially curing a dental modeling material of the dental model prior to disposing the dental model on the tray base.

5. A method in accordance with claim 1, wherein a dental modeling material of the dental model is cured at least 70% prior to disposing the dental model on the tray base or prior to drilling the at least one registration pin hole.

6. A method in accordance with claim 1, wherein a material of the dental model and a material of the tray base are substantially set prior to drilling the at least one registration pin hole.

7. A method in accordance with claim 1, wherein drilling the at least one registration pin hole includes drilling the at least one registration pin hole after a dental modeling material of the dental model and a material of the tray base are substantially set.

8. A method in accordance with claim 1, wherein drilling the at least one registration pin hole includes drilling the at least one registration pin hole in both the tray base and the dental model while the dental model is disposed on the tray base.

9. A method in accordance with claim 1, wherein obtaining the dental model includes forming the dental model prior to disposing the dental model on the tray base.

10. A method in accordance with claim 1, wherein obtaining the dental model includes obtaining a dental model formed by a rapid prototyping method selected from the group consisting of milling, CNC milling, 3D printing, and combinations thereof.

11. A method in accordance with claim 1, wherein obtaining the dental model includes obtaining a dental model formed by applying dental casting material to a negative impression of a patient's teeth.

12. A method in accordance with claim 1, wherein the tray base has a flat upper surface for receiving the dental model.

13. A method in accordance with claim 1, wherein the tray base has indentations formed in an upper surface for receiving the dental model.

14. A method in accordance with claim 1, wherein drilling the at least one registration pin hole includes drilling at least one tapered hole.

15. A method in accordance with claim 1, further comprising fixing the at least one registration pin to the dental model.

16. A method in accordance with claim 1, further comprising fixing the at least one registration pin to the tray base.

17. A method in accordance with claim 1, further comprising segmenting the dental model on either side of the at least one registration pin hole.

18. A method for registering a dental model on a tray base, comprising:
a) obtaining a dental model of at least some of a patient's teeth, the dental model including a dental modeling material that is substantially cured;
b) disposing the dental model on a tray base;
c) drilling at least one registration pin hole from a bottom of the tray base, through the tray base, and into a bottom of the dental model while the dental model is disposed on the tray base and after both a material of the tray base and the dental modeling material of the dental model are substantially set;
d) inserting at least one registration pin into the at least one registration pin hole with the at least one registration pin extendable between the dental model and the tray base; and
e) fixing the at least one registration pin to the dental model or the tray base.

19. A method in accordance with claim 18, wherein the tray base is formed of a dental modeling material that is substantially cured.

20. A method for registering a dental model on a tray base, comprising:
a) obtaining a dental model of at least some of a patient's teeth, the dental model including a dental modeling material that is substantially cured;
b) disposing the dental model on a plastic tray base;
c) drilling at least one registration pin hole from a bottom of the tray base, through the tray base, and into a bottom of the dental model while the dental model is disposed on the tray base and after the dental modeling material of the dental model is substantially cured; and
d) inserting at least one registration pin into the at least one registration pin hole with the at least one registration pin extendable between the dental model and the tray base.

21. A method in accordance with claim 20, further comprising fixing the at least one registration pin to the dental model or the tray base.
